(19) United States
(12) Patent Application Publication
(10) Pub. No.: US 2013/0031471 A1
(43) Pub. Date: Jan. 31, 2013

(54) ELECTRONIC DOCUMENT RASTERIZING METHOD AND ELECTRONIC DOCUMENT RASTERIZING DEVICE

(71) Applicants: Wenhui Xu, Beijing (CN); Cheng Du, Beijing (CN); Fumihiro Hasegawa, Tokyo (JP); Koichi Inoue, Kanagawa (JP)

(72) Inventors: Wenhui Xu, Beijing (CN); Cheng Du, Beijing (CN); Fumihiro Hasegawa, Tokyo (JP); Koichi Inoue, Kanagawa (JP)

(73) Assignee: RICOH COMPANY, LTD., Tokyo (JP)

(21) Appl. No.: 13/468,101

(22) Filed: May 10, 2012

(30) Foreign Application Priority Data
Jul. 25, 2011 (CN) 201110208087.8

(51) Int. Cl. G06F 17/00

(52) U.S. Cl. 715/251

(57) ABSTRACT

Disclosed are an electronic document rasterizing method and an electronic document rasterizing device. The method comprises a thumbnail image rasterizing step of calculating an initial resolution for rasterizing a thumbnail image of the electronic document page, and then carrying out rasterization with regard to the thumbnail image of the electronic document page; an electronic document page dividing step of dividing, based on a designated resolution and the size of a display area, the electronic document page into plural regional segments; a region-of-interest determining step of determining, in response of designation of a position of interest, a current region of interest in the plural regional segments; and a region-of-interest rasterizing step of determining at least one document segment belonging to the current region of interest, and then rasterizing the current region of interest by rasterizing the document segment belonging to the current region of interest based on the designated resolution.

### BACKGROUND OF THE INVENTION

1. Field of the Invention

The present invention relates to an electronic document rasterizing method and an electronic document rasterizing device.

2. Description of the Related Art

Electronic documents have been widely used in everyday office work in recent years. For example, a PDF (Portable Document Format) or PS (PostScript) document is getting considerable attention due to the advantage that its format is unchanged when used in various display apparatuses. Compared to a personal computer (PC), an apparatus such as a mobile intelligent terminal, a printer, a mobile phone, or a personal digital assistance (PDA), etc., usually has a small display screen, and the processing ability of its processor is much lower than that of a processor of the PC. As a result, in a case where an electronic document having a portable document format needs to be displayed on the display screen of the apparatus, when the electronic document is loaded into the apparatus, since the performance of the apparatus is very low, its processing speed is usually very slow, and its response time is usually very long. Furthermore a user may only clearly read a part of a page of the electronic document at once, for the display screen of the apparatus is very small. If the user wants to read the whole page, then he needs to frequently carry out switching between a local display mode and a thumbnail display mode. In other words, a conventional method of rasterizing the whole page of an electronic document obviously cannot satisfy the actual needs of the user.

In what follows, a few technical terms used in the field of electronic document rasterization are introduced as follows:

(1) Rasterization

Rasterization, also called “rendering”, indicates a process of converting a vector image into a bitmap in general. Here it indicates a process of converting a page of an electronic document (hereinafter, sometimes called an “electronic document page” or “document page”) into a bitmap. The rasterization is an essential process when displaying or printing the electronic document. The rasterization of the electronic document may be achieved by making use of various well known techniques.

(2) Document Segment

A document segment is the basic component element of an electronic document. The document segment may be a character segment, an image segment, or a graphic segment, etc. For example, a character displayed by one command is the character segment, an image displayed by one command is the image segment, and a graphic displayed by one command is the graphic segment.

(3) Thumbnail Image and Thumbnail Display

Displaying the whole page of an electronic document on a relatively small display screen is called a “thumbnail display”, and the whole page displayed on the relatively small display screen is called a “thumbnail image”. In a thumbnail display mode, a user usually cannot recognize the particulars of an electronic document.

On the other hand, there are two patent documents related to the field of the present invention. They are introduced as follows:

US Patent Application Publication No. 2005/0286063 A1 discloses a method including a step of converting electronic document data into printing instructions; a step of providing a document segment selecting function to a user; and a step of providing different printing configurations for printing the document segments selected by the user. This patent document mainly proposes an electronic document segment extracting method, but it does not relate to rapid rasterization carried out with regard to a part of an electric document.

US Patent Application Publication No. 2009/0195811 A1 discloses that printing of an electronic document may be divided into a character mode and a non-character mode. In the character mode, rasterization of the electronic document may be very fast. However, this patent document does not propose a method of rapidly and locally rasterizing an electronic document, able to be applied to an apparatus such as a portable mobile apparatus, etc., having a small display screen.

### SUMMARY OF THE INVENTION

The present invention seeks to solve the above described problems in the prior art. In embodiments of the present invention, an electronic document rasterizing method and an electronic document rasterizing device are proposed by which an electronic document may be rasterized rapidly and locally.

According to one aspect of the present invention, an electronic document rasterizing method is provided. The electronic document rasterizing method comprises a thumbnail image rasterizing step of calculating, based on both a size of a display area and a size of an electronic document page, an initial resolution for rasterizing a thumbnail image of the electronic document page, and then carrying out rasterization with regard to the thumbnail image of the electronic document page by utilizing the initial resolution; an electronic document page dividing step of dividing, based on a designated resolution and the size of the display area, the electronic document page into plural regional segments; a region-of-interest determining step of determining, in response of designation of a position of interest, a current region of interest in the plural regional segments; and a region-of-interest rasterizing step of determining at least one document segment in the electronic document page, belonging to the current region of interest, and then by rasterizing, based on the designated resolution, the document segment belonging to the current region of interest, rasterizing the current region of interest.

According to another aspect of the present invention, an electronic document rasterizing device is provided. The electronic document rasterizing device comprises a thumbnail image rasterizing unit configured to calculate, based on both a size of a display area and a size of an electronic document page, an initial resolution for rasterizing a thumbnail image of the electronic document page, and then to carry out rasterization with regard to the thumbnail image of the electronic document page by utilizing the initial resolution; an electronic document page dividing unit configured to divide, based on a designated resolution and the size of the display area, the electronic document page into plural regional segments; a region-of-interest determining unit configured to determine, in response of designation of a position of interest, a current region of interest in the plural regional segments; and a region-of-interest rasterizing unit configured to determine at least one document segment in the electronic document page, belonging to the current region of interest, and then by rasterizing, based on the designated resolution, the document segment belonging to the current region of interest, to rasterize the current region of interest.

The electronic document rasterizing method and the electronic document rasterizing device according to the embodiments of the present invention may be applied to the field of electronic document rasterization. By utilizing the electronic document rasterizing method and the electronic document rasterizing device according to the embodiments of the present invention, it is possible to achieve rapid and local display of an electronic document on a small display screen belonging to an apparatus such as a portable mobile apparatus (for example, a mobile phone or an mobile intelligent terminal), etc.

### BRIEF DESCRIPTION OF THE DRAWINGS

FIG. 1 is an overall flowchart of an electronic document rasterizing method according to an embodiment of the present invention;

FIG. 2 illustrates an example of a rasterized thumbnail image of a page of an electronic document;

FIG. 3 illustrates an example of dividing an electronic document page into plural regional segments;

FIG. 4A illustrates an example of an overlap of a character segment and a regional segment;

FIG. 4B illustrates an example of an overlap of a graphic segment and a regional segment;

FIG. 4C illustrates an example of an overlap of an image segment and a regional segment;

FIG. 5 illustrates an example of a result of performing rasterization with regard to a local regional segment;

FIG. 6 illustrates an example of a positional relationship between a region of interest and its adjacent regional segments; and

FIG. 7 is an overall block diagram of an electronic document rasterizing device according to an embodiment of the present invention.

### DETAILED DESCRIPTION OF THE PREFERRED EMBODIMENTS

Hereinafter, various embodiments of the present invention will be concretely described with reference to the drawings. However it should be noted that the same symbols, which are in the specification and the drawings, stand for constructional elements having basically the same function and structure, and repeated explanations for the constructional elements are omitted.

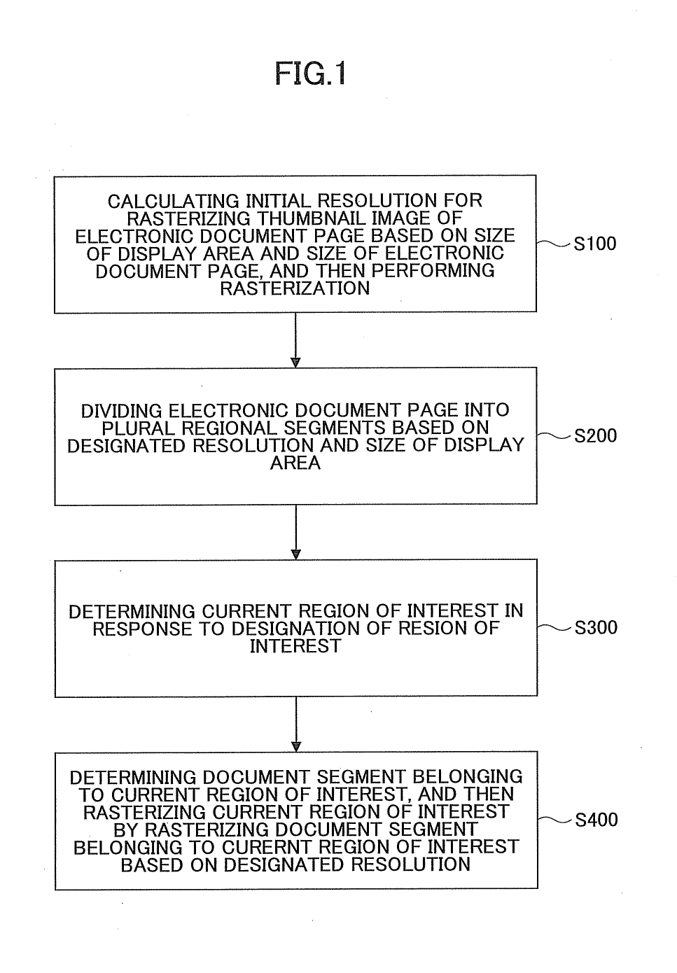

FIG. 1 is an overall flowchart of an electronic document rasterizing method according to an embodiment of the present invention.

As shown in FIG. 1, the electronic document rasterizing method includes a thumbnail image rasterizing step S100 of calculating, based on the size of a display area and the size of an electronic document page, an initial resolution for rasterizing a thumbnail image of the electronic document page, and then rasterizing the thumbnail image of the electronic document page by using the initial resolution; a document page dividing step S200 of dividing the electronic document page into plural regional segments based on a designated resolution and the size of the display area; a region-of-interest determining step S300 of determining a current region of interest in the plural regional segments in response to designation of a position of interest; and a region-of-interest rasterizing step S400 of determining a document segment belonging to the current region of interest in the electronic document page, and then rasterizing the current region of interest by rasterizing the document segment belonging to the current region of interest based on the designated resolution.

In STEP S100, a low resolution (i.e. the initial resolution) is used to rasterize the whole electronic document page (for example, a whole PDF document page) so as to generate a rasterized thumbnail image for purpose of display. Here the low resolution used for the thumbnail image rasterization may be calculated based on the size of the input electronic document page and the size of the display area of a display screen in a display apparatus. The thumbnail image rasterization does not need to occupy a great deal of system resources; as a result, it requires less time. Consequently a user may rapidly obtain the full view of the whole electronic document page. As describe below, the full view of the whole electronic document page may be used to select a region of interest therein for enlargement and reading.

Here it should be noted that in a case where the display apparatus utilizes the full screen to display the electronic document page, the size of the display area is just equal to the size of the display screen, while in a case where a part of the display screen is opted for displaying the electronic document page, by making use of any proper conventional means, it is possible to detect the size of the display area and its positional range on the display screen.

Moreover, in the thumbnail image rasterizing step S100, the initial resolution may be computed by adopting the following equations (1) to (3).

res_thumbnail=min(a×min(hscale,wscale),b) (1)

wscale=wpanel/wpage (2)

hscale=hpanel/hpage (3)

Here wpanel refers to the width of the display area; hpanel refers to the height of the display area; wpage refers to the width of the electronic document page in a document user space; hpage refers to the height of the electronic document page in the document user space; min( ) refers to calculating a minimum value; a refers to a mapping coefficient from the document user space to a display apparatus space; b refers to a default resolution of the thumbnail image of the electronic document page; res_thumbnail refers to the initial resolution for rasterizing the thumbnail image of the electronic document page; wscale refers to a ratio of the width of the display area to the width of the electronic document page in the document user space; and hscale refers to a ratio of the height of the display area to the height of the electronic document page in the document user space.

In a case where the electronic document is, for example, a PDF document, the mapping coefficient a from the document user space to the display apparatus space may be 72. The default resolution b of the thumbnail image of the electronic document page may be set to 24 dpi (dots per inch), i.e., b may be 24. In order to increase the speed of rasterizing the thumbnail image of the electronic document page, if the computed resolution a×min(hscale,wscale) is greater than 24 dpi, then the resolution of the thumbnail image of the electronic document page is set to 24 dpi, while if the computed resolution a×min(hscale,wscale) is less than 24 dpi, then the computed resolution serves as the initial resolution for rasterizing the thumbnail image of the electronic document page.

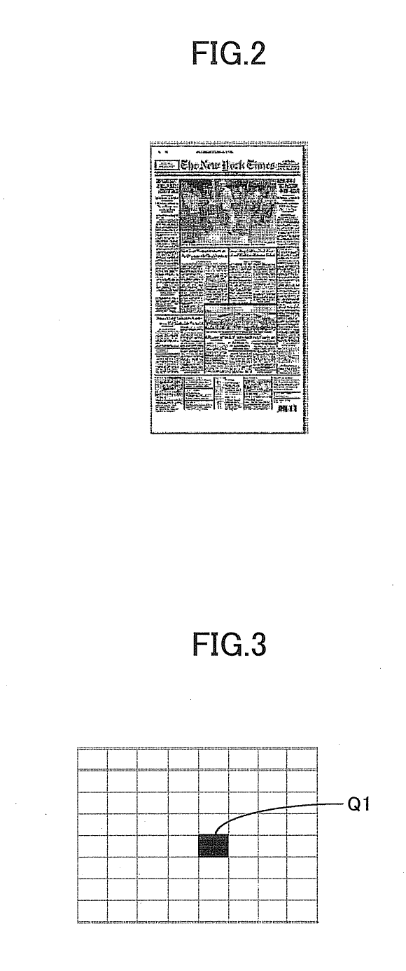

For instance, FIG. 2 illustrates an example of a rasterized thumbnail image obtained by carrying out the thumbnail image rasterizing step S100 with regard to a thumbnail image of an electronic document page.

Referring to FIG. 1 again; in STEP S200, the electronic document page is divided into the plural regional segments based on the designated resolution and the size of the display area. Here the designated resolution may be higher than the initial resolution. The designated resolution may be designated by a user. In particular, the designated resolution may be one of various resolutions input by a user, or may be a converted resolution corresponding to a position of a scroll bar in response to a moving operation of a device able to achieve a real or virtual scroll bar function, executed by the user. It is possible to calculate, based on the designated resolution, a display size by which the electronic document page should be displayed under the condition of the designated resolution. Then it is possible to obtain, by dividing the size of the electronic document page corresponding to the designated resolution by the size of the display area, the number of rows and columns by which the electronic document page should be divided under the condition of the designated resolution.

Furthermore, in STEP S200, the number of rows and columns of regional segments for dividing the electronic document page may be determined by adopting the following equations (4) and (5).

wnumber=wpage×(res_input/a)/wpanel+1 (4)

hnumber=hpage×(res_input/a)/hpanel+1 (5)

Here wpanel refers to the width of the display area; hpanel refers to the height of the display area; wpage refers to the width of the electronic document page in the document user space; hpage refers to the height of the electronic document page in the document user space; a refers to the mapping coefficient from the document user space to the display apparatus space; res_input refers to the designated resolution; wnumber refers to the number of columns of the regional segments for dividing the electronic document page; and hnumber refers to the number of rows of the regional segments for dividing the electronic document page. In addition, it should be noted that if the operation of division is not divisible, then the remainder may be rounded off, rounded up, or rounded down; or may be processed in any other suitable ways.

For instance, FIG. 3 illustrates an example of dividing an electronic document page into plural regional segments; here the whole page is divided into 8 rows and 8 columns, i.e., 64 regional segments.

Referring to FIG. 1 again; in STEP S300, a current region of interest (ROI) in the plural regional segments is determined in response to designation of a position of interest. In particular, the designation of the position of interest may be performed based on one of various operations input by a user. For example, the user may use his finger, a pen, or a probe to designate the position of interest on the display area by carrying out a click or touch operation, etc. Moreover the determination of the current region of interest may be achieved by finding a regional segment to which the designated position of interest belongs, and then letting the regional segment serve as the current region of interest.

For instance, as shown in FIG. 3, a regional segment Q1 represents a designated current region of interest.

Next, in STEP S400 of FIG. 1, the current region of interest selected by the user is rasterized according to the higher resolution (i.e., the designated resolution). In general, the display screen size of a mobile apparatus is very small; as a result, in a thumbnail display mode, the user cannot read the particulars of an electronic document.

After the current region of interest is selected by the user, it is rasterized by using the higher resolution, and then is displayed. After that or at the same time, it is possible to store the rasterized result, for example, a rasterized bitmap, by carrying out background processing.

Moreover it is possible to determine at least one document segment belonging to the current region of interest, in the electronic document page, and then the determined document segment in the electronic document page may be rasterized. Rasterizing an electronic document page or a part of that substantively means rasterizing at least one document segment in the electronic document page. In a case where the initial resolution (i.e., a lower resolution) is opted for rasterizing a whole electronic document page in a thumbnail display mode, it is not necessary to determine a document segment that needs to be rasterized. However, in a case where a region of interest needs to be rasterized, it is necessary to determine a document segment in the electronic document page, belonging to the region of interest, needing to be rasterized at first.

Here it is assumed that document segments of an electronic document page are classified into three categories, namely a character segment category, an image segment category, and a graphic segment category. A positional relationship between a regional segment (obtained by dividing the electronic document page based on both the designated revolution and the display area size) and a document segment may be an inclusive relationship, a full overlap relationship, or a partial overlap relationship.

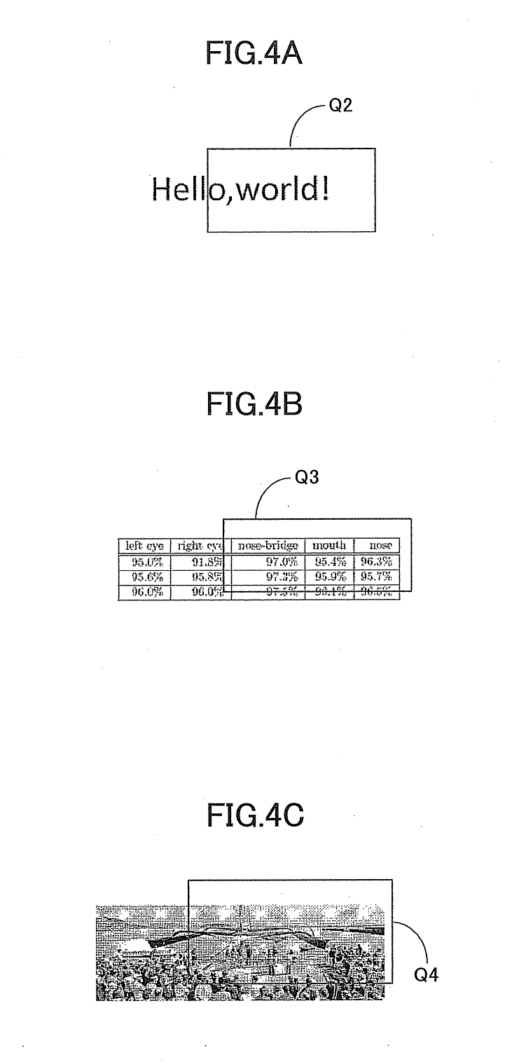

FIG. 4A illustrates an example of a partial overlap of a character segment and a regional segment.

FIG. 4B illustrates an example of a partial overlap of a graphic segment and a regional segment.

FIG. 4C illustrates an example of a partial overlap of an image segment and a regional segment.

It is possible to determine, by utilizing the following equations (6) to (9), at least one document segment in an electronic document page, belonging to a regional segment prepared to be rasterized.

$$\begin{matrix} {V}_{elements} = \{ {T}_{elements} , {I}_{elements} , {G}_{elements} \} & ( 6 ) \\ {T}_{elements} = \{ ∀ textRun \vert Area ( BBox ( textRun ) ⋂ region ) > 0 \} & ( 7 ) \\ {I}_{elements} = \{ ∀ image \vert \frac{Area ( BBox ( image ) ⋂ region )}{min ( Area ( BBox ( image ) ) , Area ( region ) )} > {σ}_{1} \} & ( 8 ) \\ {G}_{elements} = \{ ∀ graphic \vert \frac{Area ( BBox ( graphics ) ⋂ region )}{min ( Area ( BBox ( graphics ) ) , Area ( region ) )} > {σ}_{2} \} & ( 9 )\end{matrix}$$

Here Vₑₗₑₘₑₙₜₛ refers to a document segment set of the regional segment; Tₑₗₑₘₑₙₜₛ refers to a character segment set of the regional segment; Iₑₗₑₘₑₙₜₛ refers to an image segment set of the regional segment; Gₑₗₑₘₑₙₜₛ refers to a graphic segment set of the regional segment; BBox( ) refers to calculation of a minimum circumscribed rectangle; Area( ) refers to calculation of an area value; textRun refers to a character segment in the electronic document page; image refers to an image segment in the electronic document page; graphic refers to a graphic segment in the electronic document page; region refers to the regional segment prepared to be rasterized; and σ₁ and σ₂ refer to predetermined proportional values.

In what follows, how to control the final appearance of a document segment by employing PDF operators, in a case where the electronic document is a PDF document, is illustrated according to FIGS. 4A to 4C and the above equations (6) to (9).

For example, as for a PDF file source code “(Hello, World!)Tj”, “Tj” thereof refers to a character display operator, and “Hello, World!” thereof refers to a character string prepared to be displayed; as a result, by executing the source code, a character segment is displayed as shown in FIG. 4A. In addition, as mentioned above, BBox refers to calculation of a minimum circumscribed rectangle corresponding to a PDF document segment; therefore it is possible to acquire the minimum circumscribed rectangle of the PDF document segment by using any proper conventional techniques. region refers to a regional segment obtained by dividing the PDF document page, and may be a region of interest, namely a current region of interest selected by a user.

The above equations (6) to (9) may be applied to a circumstance where a regional segment and a document segment partially overlap, and may also be applied to a circumstance where the two fully overlap, or the two have an inclusive relationship. By utilizing the above equations (6) to (9), it is possible to determine, in an electronic document page, at least one document segment belonging to a regional segment currently being processed; the determined document segment will be rasterized later. Here it should be noted that if the regional segment currently being processed is a current region of interest, i.e., if it is determined that at least one document segment in the electronic document page belongs to the current region of interest, then the document segment determined by utilizing the above equations (6) to (9) is regarded as a document segment belonging to the current region of interest, and may be used in a follow-on rasterizing process carried out with regard to the current region of interest.

Referring to FIG. 4A; as for a character segment, if its corresponding minimum circumscribed rectangle overlaps with a current region of interest (for example, a rectangle Q2), then the character segment will be processed in a follow-on local region rasterizing process.

Referring to FIG. 4B; regarding a graphic segment, if its corresponding minimum circumscribed rectangle overlaps with a current region of interest (for example, a rectangle Q3), and the overlap area is greater than an area value obtained by multiplying a predetermined proportional value σ₂ (for example, σ₂=30%) by a smaller one of the area of the minimum circumscribed rectangle and the area of the current region of interest, then the graphic segment will be processed in a follow-on local region rasterizing process; otherwise the graphic segment is skipped.

Referring to FIG. 4C; with regard to an image segment, it may be processed in a similar way that the graphic segment is processed. That is, if its corresponding minimum circumscribed rectangle overlaps with a current region of interest (for example, a rectangle Q4), and the overlap area is greater than an area value obtained by multiplying a predetermined proportional value σ₁ (for example, σ₁=30%) by a smaller one of the area of the minimum circumscribed rectangle and the area of the current region of interest, then the image segment will be processed in a follow-on local region rasterizing process; otherwise the image segment is skipped.

Here it should be noted that σ₁ and σ₂ may be parameters set by a user, serving as threshold values for determining whether the document segments will be processed in the follow-on local region rasterizing process. The values of the two may be the same, or may be different. Moreover the values of the two are not limited to 30%; in other words, they may be, for example, 20%, 40%, 60%, or 75%.

In addition, each document segment in the electronic document page needs to be determined whether the corresponding document segment satisfies the above equations (6) to (9). When carrying out rasterization with regard to the current region of interest, if the corresponding document segment satisfies the above equations (6) to (9), then it is rasterized; otherwise, it is skipped.

After that, it is possible to rasterize, based on the designated revolution, the document segment belonging to the current region of interest by employing any proper conventional rasterizing approaches so as to rasterize the current region of interest for purpose of display. As a result, by performing rasterization with regard to a region of interest according to a higher resolution, a user may recognize the particulars of an electronic document page.

Since a region of interest may only be a part of a whole electronic document page, the time of locally rasterizing the region of interest may be significantly shorter than that of rasterizing the whole electronic document page in a case where a same higher resolution, for example, 150 dpi, is used.

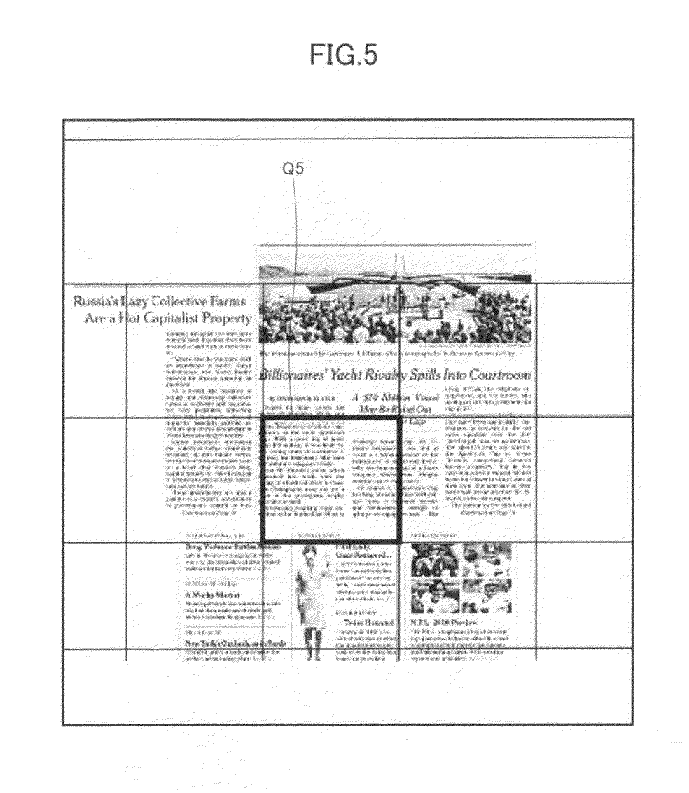

For instance, FIG. 5 illustrates an example of a result of performing rasterization with regard to a local regional segment.

In FIG. 5, a rectangle Q5 represents a local regional segment prepared to be rasterized. In a case as shown in FIG. 5, according to experimental data, the time of rasterizing the whole electronic page is 2.5 seconds, while the time of rasterizing the rectangle Q5 of the local regional segment is only 1.3 seconds.

In addition, the electronic document rasterizing method according to the embodiments of the present invention may further contain a region-of-interest change detecting step of detecting an operation for changing a region of interest. In this step, in response of the detected operation for changing the region of interest, the position of the region of interest in the electronic document page is changed, then the changed region of interest is determined as a current region of interest, and then the above described region-of-interest rasterizing step S400 is carried out with regard to the current region of interest.

The region-of-interest change detecting step may be executed at any time point after the region-of-interest determining step S300. For example, in a case where an operation for changing a region of interest, input by a user is detected after the region of interest is determined in the region-of-interest determining step S300, it is possible to interrupt, in response to the detected operation for changing the region of interest, a process such as a rasterization process being performed, then to determine a new region of interest obtained after the detected operation is executed as a current region of interest, and then to carry out the region-of-interest rasterizing step S400 so as to rasterize the new region of interest.

Here it should be noted that the operation for changing the region of interest, input by the user may be triggering a control button, scrolling a touch panel, or any other proper operations able to cause the region of interest to change its position with respect to the electronic document page.

Furthermore, at the same time when a user is reading a region of interest, it is possible to carry out background rasterization with regard to an adjacent region of the region of interest, and then to store the rasterized result, for example, a rasterized bitmap, in a memory unit such as a system buffer. In this way, after the user changes the region of interest, if the obtained new region of interest has been partially or fully rasterized, and the rasterized result has been stored in the system buffer, then the rasterized result may be directly called so as to shorten the processing time.

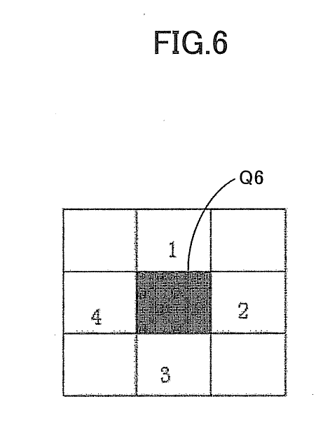

FIG. 6 illustrates an example of a positional relationship between a region of interest and its adjacent regional segments.

In FIG. 6, a rectangle Q6 refers to a region of interest, and rectangles 1, 2, 3, and 4 refer to adjacent regional segments of the region of interest. It is possible to perform, in a certain order, rasterization with regard to the adjacent regional segments of the region of interest, and then to store the rasterized results in a memory unit such as a system buffer.

In other words, the electronic document rasterizing method according to the embodiments of the present invention may further include an adjacent regional segment rasterizing step. In a case where the position of a region of interest is not changed, it is possible to determine, in a default order of rasterizing adjacent regional segments of the region of interest, document segments in the electronic document page, belonging to the adjacent regional segments, and then to rasterize the adjacent regional segments of the current region of interest.

For instance, as shown in FIG. 6, in a case where the rectangle Q6 is a region of interest, it is possible to adopt a simple order, i.e., 3->4->1->2 to serve as a default order of rasterizing the adjacent regional segments of the rectangle Q6 of the region of interest.

In addition, a character arranging direction may be considered too. The character arranging direction may be acquired by utilizing any proper conventional approaches. Here it should be noted that in general, the character arranging direction is classified into two catalogues, namely horizontal and vertical. The horizontal character arranging direction indicates that characters are laid out from left to right and from top to bottom (i.e., horizontal writing). The vertical character arranging direction indicated that characters are laid out from top to bottom and from right to left (i.e., horizontal writing).

For example, in a case where the character arranging direction is horizontal, it is possible to adopt an order of 3->4->1->2 to serve as the default order. In a case where the character arranging direction is vertical, it is possible to adopt an order of 3->1->2->4 to serve as the default order.

Also it should be noted that the default order of rasterizing the adjacent regional segments of the region of interest is not limited to the above mentioned orders; that is, regardless of a character arranging direction, clock rotation, or clockwise rotation, it is possible to adopt any order starting from any one of the adjacent regional segments to serve as the default order.

In a word, as long as the adjacent regional segments of a region of interest have been rasterized in the background, and the rasterized results have been stored in a memory unit such as a system buffer, in a case where the region of interest is changed later, it is possible to improve the processing speed.

Moreover, by letting each of the adjacent regional segments prepared to be rasterized be the region in the above equations (6) to (9), it is possible to utilize the above equations (6) to (9) to determine at least one document segment belonging to the corresponding adjacent regional segment, and then to rasterize the corresponding adjacent regional segment by using a designated higher resolution.

If the position of a current region of interest is changed from that of another region of interest (i.e., a preceding region of interest), then when determining an order for rasterizing the adjacent regional segments of the current region of interest, it is also possible to consider a position moving direction from the other region of interest to the current region of interest as well as the character arranging direction.

In other words, the electronic document rasterizing method according to the embodiments of the present invention may further comprise a rasterization order determining step of determining, based on the position moving direction and the character arranging direction, an order for rasterizing the adjacent regional segments of the current region of interest. In this circumstance, the adjacent regional segment rasterizing step may be, for example, if the position of the current region of interest is changed from that of another region of interest, determining an order for rasterizing the adjacent regional segments of the current region of interest according to the rasterization order determining step, then determining document segments belonging to the adjacent regional segments in the order, and then rasterizing the adjacent regional segments of the current region of interest.

It is possible to acquire the character arranging direction by adopting any proper conventional approaches, and the character arranging direction may be a horizontal or vertical one as described above.

Furthermore a user may designate a new region of interest by carrying out the above mentioned operation to change a current region of interest; for example, it is possible to change the current region of interest by dragging the displayed part of an electronic document page upward, downward, leftward, or rightward.

When determining an order for rasterizing the adjacent regional segments of a region of interest, it is also possible to take into account a connected domain rule.

Here FIG. 6 is taken as an instance again. In a case where a preceding dragging direction is downward, i.e., a preceding region of interest moved upward with respect to the electronic document page, if the character arranging direction of a current region of interest is horizontal, then an order for rasterizing the adjacent regional segments of the current region of interest may be 1->2->3->4. In a case where a preceding dragging direction is upward, i.e., a preceding region of interest moved downward with respect to the electronic document page, if the character arranging direction of a current region of interest is horizontal, then an order for rasterizing the adjacent regional segments of the current region of interest may be 3->4->1->2. In a case where a preceding dragging direction is rightward, i.e., a preceding region of interest moved leftward with respect to the electronic document page, if the character arranging direction of a current region of interest is horizontal, then an order for rasterizing the adjacent regional segments of the current region of interest may be 4->2->1->3. In a case where a preceding dragging direction is leftward, i.e., a preceding region of interest moved rightward with respect to the electronic document page, if the character arranging direction of a current region of interest is horizontal, then an order for rasterizing the adjacent regional segments of the current region of interest may be 2->4->1->3.

In a case where the character arranging direction of a current region of interest is vertical, if a preceding dragging direction is downward, then an order for rasterizing the adjacent regional segments of the current region of interest may be 1->3->2->4; if a preceding dragging direction is upward, i.e., a preceding region of interest moved downward with respect to the electronic document page, then an order for rasterizing the adjacent regional segments of the current region of interest may be 3->1->2->4; if a preceding dragging direction is leftward, i.e., a preceding region of interest moved rightward with respect to the electronic document page, then an order for rasterizing the adjacent regional segments of the current region of interest may be 4->1->2->3; or if a preceding dragging direction is rightward, i.e., a preceding region of interest moved leftward with respect to the electronic document page, then an order for rasterizing the adjacent regional segments of the current region of interest may be 2->3->4->1.

Moreover, by letting each of the adjacent regional segments prepared to be rasterized be the region in the above equations (6) to (9), it is possible to utilize the above equations (6) to (9) to determine at least one document segment belonging to the corresponding adjacent regional segment, and then to rasterize the corresponding adjacent regional segment by using a designated higher resolution.

During a process of rasterizing the adjacent regional segments of a current region of interest, if it is detected that a user has executed an operation for changing the current region of interest, then the rasterization being performed is interrupted, and then the obtained new region of interest is rasterized. At this time, if the new region of interest fully or partially belongs to the adjacent regional segments of the current region of interest, and is fully or partially rasterized, then the rasterized result may be directly read from a system buffer for display; in this way, the processing speed may be improved.

Furthermore, during a process of carrying out the electronic document rasterizing method according to the embodiments of the present invention, a user may designate a resolution at any time by any proper conventional means, for example, a zooming and displaying operation. If a new resolution is designated, that means a preceding resolution is changed.

In other words, the electronic document rasterizing method according to the embodiments of the present invention may further include a resolution change detecting step of detecting an operation for changing a resolution, then in response to the operation, letting the changed resolution serve as the above mentioned designated resolution, and then carrying out the above described electronic document page dividing step S200.

For instance, after the electronic document page dividing step S200 is performed, or during a process in which the electronic document page dividing step S200 is being performing, if an operation for changing a current resolution, input by a user is detected, then in response to the detected operation, the processing being performed, such as the electronic document page dividing step 200, the region-of-interest determining step S300, or the region-of-interest rasterizing step S400 is interrupted. After that, the electronic document page dividing step S200 is re-executed at once in which the changed resolution serves as the above mentioned designated resolution, and the electronic document page is divided again.

In addition, the electronic document rasterizing method according to the embodiments of the present invention may further comprise a storage step of storing resources used in the rasterization carried out with regard to the regional segments, and the rasterized results, etc.

Regardless of what the designated resolution is, it is possible to store the electronic document page dividing method, the rasterized result of a region of interest, and the rasterized results of the adjacent regional segments of the region of interest (for example, rasterized bitmaps) which correspond to the designated resolution. In this way, in a case where it is necessary to re-load any one of the rasterized results under the condition of the designated resolution for purpose of display, it is possible to directly call and display the corresponding rasterized result. As a result, the dividing process and the rasterizing process may be fully or partially omitted.

Furthermore, when an electronic document page such as a PDF document page is rasterized under a resolution, the rasterization needs to utilize some common resources such as a font file, a decoded document page content stream, and a decoded image stream, etc. When an electronic document page is rasterized according to a certain resolution for the first time, it is possible to store the above common resources. In doing this way, when the same electronic document page is rasterized according to another resolution later, it is possible to directly load the common resources so as to save the processing time.

Moreover, as for both the rasterized result of a regional segment of an electronic document page and the common resources needed in the rasterization, it is possible to adopt various storage approaches such as storing in files, storing in a memory, or storing in a buffer, etc., to store them. In this way, when needing to be used later, they may be directly called so as to improve the processing speed.

In the electronic document rasterizing method according to the embodiments of the present invention, it is also possible to automatically carry out multi-resolution rasterization with regard to an input electronic document page in background so that a user may rapidly perform switching between any two of the multiple resolutions. Here it should be noted that the multi-resolution electronic document page rasterizing process may be conducted after the user changes a resolution, at the same time when the user is reading the particulars of a region of interest of the electronic document page, or in a case where the user does not designate or change a resolution. The generated bitmaps may be stored in a buffer. For that, when the user carries out switching from a resolution to another, the corresponding bitmap may be directly loaded.

In addition, during the multi-resolution rasterization process, if the user performs a switching operation such as dragging a region of interest, or changing a resolution, etc., then the multi-resolution rasterization process is interrupted, and then a process such as the region-of-interest rasterizing process or the document page dividing process corresponding to an operation of the user is conducted.

For instance, in a case where it is assumed that the above multi-resolution rasterization process is carried out by utilizing the following resolutions, namely 24 dpi, 72 dpi, 96 dpi, 120 dpi, and 150 dpi. Under the different resolutions, the numbers of divided regional segments are different too. The higher a resolution is, the greater the number of the divided regional segments is. In general, the lowest resolution corresponds to the thumbnail image of a whole document page; therefore, in this circumstance, there is no local region division.

In a multi-resolution rasterization process, each of local regional segments of an electronic document page is rasterized under each of resolutions in an order from low to high. Then the rasterized results, for example, rasterized bitmaps, are stored. By doing this, when one of the regional segments needs to be displayed under one of the resolutions, it is possible to call the corresponding rasterized result so that the waiting time of the user may be decreased.

Moreover, in a multi-resolution rasterization process, when a resolution is employed to rasterizing an electronic document page for the first time, the common resources corresponding to this resolution may be acquired from, for example, electronic document files, and then may be stored in, for example, a memory unit. In this way, in a later rasterization process under another resolution, it is possible to directly read the common resources stored in the memory unit so as to shorten the rasterizing time.

According to another aspect of the present invention, an electronic document page rasterizing device is provided.

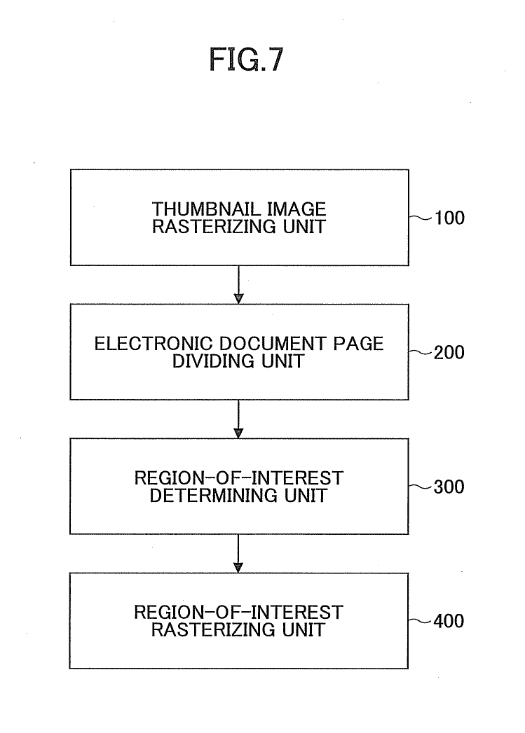

FIG. 7 is an overall block diagram of an electronic document rasterizing device according to an embodiment of the present invention.

As shown in FIG. 7, the electronic document rasterizing device according to the embodiment of the present invention may include a thumbnail image rasterizing unit 100 configured to execute the above described thumbnail image rasterizing step S100 so as to calculate, based on the size of a display area and the size of an electronic document page, an initial resolution for rasterizing a thumbnail image of an electronic document page, and then carry out rasterization with regard to the thumbnail image of the electronic document page by utilizing the initial resolution; an electronic document page dividing unit 200 configured to execute the above described electronic document page dividing step S200 so as to divide, based on a designated resolution and the size of the display area, the electronic document page into plural regional segments; a region-of-interest determining unit 300 configured to execute the above described region-of-interest determining step S300 so as to determine, in response to designation of a position of interest, a current region of interest in the plural regional segments; and a region-of-interest rasterizing unit 400 configured to execute the above described region-of-interest rasterizing step S400 so as to determine a document segment in the electronic document page, belonging to the current region of interest, and then to rasterize the current region of interest by rasterizing, based on the designated resolution, the document segment belonging to the current region of interest.

The electronic document page dividing unit 200 determines both the number of rows and the number of columns of regional segments for dividing the electronic document page by using the following equations (10) and (11).

wnumber=wpage×(res_input/a)/wpanel+1 (10)

hnumber=hpage×(res_input/a)/hpanel+1 (11)

Here wpanel refers to the width of the display area; hpanel refers to the height of the display area; wpage refers to the width of the electronic document page in a document user space; hpage refers to the height of the electronic document page in the document user space; a refers to a mapping coefficient from the document user space to a display apparatus space; res_input refers to the designated resolution; wnumber refers to the number of columns of the regional segments for dividing the electronic document page; and hnumber refers to the number of rows of the regional segments for dividing the electronic document page.

An electronic document rasterizing unit according to an embodiment of the present invention may further include a resolution change detecting unit configured to execute the above described resolution change detecting step so as to detect an operation for changing a resolution, and then in response to the detected operation for changing the resolution, by letting the changed resolution serve as the designated resolution, to cause the electronic document page dividing unit 200 to divide the electronic document page.

The thumbnail image rasterizing unit 100 may calculate the initial resolution by utilizing the following equations (12) to (14).

res_thumbnail=min(a×min(hscale,wscale),b) (12)

wscale=wpanel/wpage (13)

hscale=hpanel/hpage (14)

Here wpanel refers to the width of the display area; hpanel refers to the height of the display area; wpage refers to the width of the electronic document page in the document user space; hpage refers to the height of the electronic document page in the document user space; min( ) refers to calculating a minimum value; a refers to the mapping coefficient from the document user space to a display apparatus space; b refers to a default resolution of the thumbnail image of the electronic document page; res_thumbnail refers to the initial resolution for rasterizing the thumbnail image of the electronic document page; wscale refers to a ratio of the width of the display area to the width of the electronic document page in the document user space; and hscale refers to a ratio of the height of the display area to the height of the electronic document page in the document user space.

An electronic document rasterizing unit according to an embodiment of the present invention may further include a region-of-interest change detecting unit configured to execute the above described region-of-interest change detecting step so as to detect an operation for changing a region of interest, then in response to the detected operation for changing the region of interest, to change the position of the region of interest in the electronic document page, and then by letting the changed region of interest serve as a current region of interest, to cause the region-of-interest rasterizing unit 400 to rasterize the current region of interest.

An electronic document rasterizing device according to an embodiment of the present invention may further include a rasterization order determining unit configured to execute the above described rasterization order determining step so as to determine, based on both a preceding changing direction and a character arranging direction of a current region of interest, a rasterization order for rasterizing the adjacent regional segments of the current region of interest.

An electronic document rasterizing device according to an embodiment of the present invention may further include an adjacent regional segment rasterizing unit configured to execute the above adjacent regional segment rasterizing step. If the position of a region of interest has been changed, the adjacent regional segment rasterizing unit may determine, according to a rasterization order for rasterizing the adjacent regional segments of a current region of interest determined by the rasterization order determining unit, document segments belonging to the adjacent regional segments in the electronic document page, and then rasterize the adjacent regional segments of the current region of interest. If the position of a region of interest is not changed, the adjacent regional segment rasterizing unit may determine, according to a default rasterization order of adjacent regional segments of the region of interest, document segments belonging to the adjacent regional segments in the electronic document page, and then rasterize the adjacent regional segments of the region of interest.

A document segment in an electronic document page may be a character segment, an image segment, or a graphic segment. It is possible to determine a document segment of a regional segment prepared to be rasterized by employing the following equations (15) to (18).

$$\begin{matrix} {V}_{elements} = \{ {T}_{elements} , {I}_{elements} , {G}_{elements} \} & ( 15 ) \\ {T}_{elements} = \{ ∀ textRun \vert Area ( BBox ( textRun ) ⋂ region ) > 0 \} & ( 16 ) \\ {I}_{elements} = \{ ∀ image \vert \frac{Area ( BBox ( image ) ⋂ region )}{min ( Area ( BBox ( image ) ) , Area ( region ) )} > {σ}_{1} \} & ( 17 ) \\ {G}_{elements} = \{ ∀ graphic \vert \frac{Area ( BBox ( graphics ) ⋂ region )}{min ( Area ( BBox ( graphics ) ) , Area ( region ) )} > {σ}_{2} \} & ( 18 )\end{matrix}$$

Here Vₑₗₑₘₑₙₜₛ refers to a document segment set of the regional segment; Tₑₗₑₘₑₙₜₛ refers to a character segment set of the regional segment; Iₑₗₑₘₑₙₜₛ refers to an image segment set of the regional segment; Gₑₗₑₘₑₙₜₛ refers to a graphic segment set of the regional segment; BBox( ) refers to calculation of a minimum circumscribed rectangle; Area( ) refers to calculation of an area value; textRun refers to a character segment in the electronic document page; image refers to an image segment in the electronic document page; graphics refers to a graphic segment in the electronic document page; region refers to the regional segment prepared to be rasterized; and σ₁ and σ₂ refer to predetermined proportional values.

An electronic document rasterizing device according to an embodiment of the present invention may further include a storage unit configured to execute the above described storage step so as to store both resources used for carrying out rasterization and the rasterized results.

An electronic document processed by the electronic document rasterizing step and device according to the embodiments of the present invention may exist in an apparatus for displaying the electronic document, i.e., the electronic document may be a local document, or the processed electronic document may also exist outside of the apparatus for displaying the electronic document, for example, in another apparatus connected via a network, i.e., the electronic document may be a remote document. A result of processing the electronic documents may be locally displayed on an apparatus for processing the electronic document, or may be remotely displayed on another apparatus connected via a wired or wireless network; and/or may be output to a local or remote printer for purpose of printing.

The electronic document rasterizing method and device according to the embodiments of the present invention may be applied to an electronic document such as a PDF or PS document. Here it should be noted that those people skilled in the art may understand that the electronic document rasterizing method and device according to the embodiments of the present invention are not up to a concrete specification of PDF format when embodied.

Speaking of a mobile apparatus or an embedded apparatus, its processing ability is low, and its display screen size is small in general. As a result, by adopting the above described electronic document rasterizing method and device according to the embodiments of the present invention, it is possible to effectively solve the problems existing in the conventional techniques as describe in the description of the related art. In doing this way, a local region of an electronic document page may be rasterized rapidly, and a better user experience may be provided too.

A series of operations described in this specification may be executed by hardware, software, or a combination of the hardware and the software. When the operations are executed by the software, a computer program may be installed in a dedicated built-in storage device of a computer so that the computer may execute the computer program. Alternatively, the computer program may be installed in a common purpose computer by which various types of processes may be executed so that the common purpose computer may execute the computer program.

For example, the computer program may be stored in a recording medium such as a hard disk or a ROM in advance. Alternatively, the computer program may be temporarily or permanently stored (or recorded) in a movable recording medium such as a floppy disk, a CD-ROM, a MO disk, a DVD, a magic disk, or a semiconductor storage device. In addition, it is also possible to provide this kind of movable recording medium as a software package.

While the present invention is described with reference to the specific embodiments chosen for purpose of illustration, it should be apparent that the present invention is not limited to these embodiments, but numerous modifications could be made thereto by those people skilled in the art without departing from the basic concept and technical scope of the present invention.

The present application is based on Chinese Priority Patent Application No. 201110208087.8 filed on Jul. 25, 2011, the entire contents of which are hereby incorporated by reference.

What is claimed is:

1. An electronic document rasterizing method comprising:
a thumbnail image rasterizing step of calculating, based on both a size of a display area and a size of an electronic document page, an initial resolution for rasterizing a thumbnail image of the electronic document page, and then carrying out, by utilizing the initial resolution, rasterization with regard to the thumbnail image of the electronic document page;
an electronic document page dividing step of dividing, based on a designated resolution and the size of the display area, the electronic document page into plural regional segments;
a region-of-interest determining step of determining, in response of designation of a position of interest, a current region of interest in the plural regional segments; and
a region-of-interest rasterizing step of determining at least one document segment in the electronic document page, belonging to the current region of interest, and then rasterizing the current region of interest by rasterizing, based on the designated resolution, the document segment belonging to the current region of interest.

2. The electronic document rasterizing method according to claim 1, wherein:
in the electronic document page dividing step, the number of rows of the plural regional segments and the number of columns of the plural regional segments are respectively determined by adopting
wnumber=wpage×(res_input/a)/wpanel+1; and
hnumber=hpage×(res_input/a)/hpanel+1,
wherein wpanel refers to a width of the display area; hpanel refers to a height of the display area; wpage refers to a width of the electronic document page in a document user space; hpage refers to a height of the electronic document page in the document user space; a refers to a mapping coefficient from the document user space to a display apparatus space; res_input refers to the designated resolution; wnumber refers to the number of columns of the plural regional segments; and hnumber refers to the number of rows of the plural regional segments.

3. The electronic document rasterizing method according to claim 1, further comprising:
a resolution change detecting step of detecting an operation for changing a resolution, and then in response to the detected operation for changing the resolution, by letting a changed resolution serve as the designated resolution, carrying out the electronic document page dividing step.

4. The electronic document rasterizing method according to claim 1, wherein:
in the thumbnail image rasterizing step, the initial resolution is calculated by utilizing
res_thumbnail=min(a×min(hscale,wscale),b);
wscale=wpanel/wpage; and
hscale=hpanel/hpage,
wherein wpanel refers to a width of the display area; hpanel refers to a height of the display area; wpage refers to a width of the electronic document page in a document user space; hpage refers to a height of the electronic document page in the document user space; min( ) refers to calculating a minimum value; a refers to a mapping coefficient from the document user space to a display apparatus space; b refers to a default resolution of the thumbnail image of the electronic document page; res_thumbnail refers to the initial resolution; wscale refers to a ratio of the width of the display area to the width of the electronic document page in the document user space; and hscale refers to a ratio of the height of the display area to the height of the electronic document page in the document user space.

5. The electronic document rasterizing method according to claim 1, further comprising:
a region-of-interest change detecting step of detecting an operation for changing a region of interest, then in response to the detected operation for changing the region of interest, changing a position of the region of interest in the electronic document page, and then by letting a changed region of interest serve as the current region of interest, carrying out the region-of-interest rasterizing step.

6. The electronic document rasterizing method according to claim 5, further comprising:
a rasterization order determining step of determining, based on both a preceding changing direction and a character arranging direction that correspond to the current region of interest, a rasterization order for rasterizing one and more adjacent regional segments of the current region of interest.

7. The electronic document rasterizing method according to claim 6, further comprising:
an adjacent regional segment rasterizing step of, if the position of the region of interest is changed, determining, according to the rasterization order of the adjacent regional segments determined in the rasterization order determining step, one and more document segments in the electronic document page, belonging to the adjacent regional segments, and then rasterizing the adjacent regional segments of the current region of interest; or if the position of the region of interest is not changed, letting the region of interest serve as the current region of interest, then determining, according to a default rasterization order of one and more adjacent regional segments of the current region of interest, one and more document segments in the electronic document page, belonging to the adjacent regional segments, and then rasterizing the adjacent regional segments of the current region of interest.

8. The electronic document rasterizing method according to claim 7, wherein:
the document segments in the electronic document page, belonging to the adjacent regional segments are classified into three categories, namely a character segment category, an image segment category, and a graphic segment category; and
at least one of the document segments in the electronic document page, belonging to each of the adjacent regional segments prepared to be rasterized are determined by employing
$$\begin{matrix} {V}_{elements} = \{ {T}_{elements} , {I}_{elements} , {G}_{elements} \} ; & \\ {T}_{elements} = \{ ∀ textRun \vert Area ( BBox ( textRun ) ⋂ region ) > 0 \} ; & \\ {I}_{elements} = \{ ∀ image \vert \frac{Area ( BBox ( image ) ⋂ region )}{min ( Area ( BBox ( image ) ) , Area ( region ) )} > {σ}_{1} \} ; and & \\ {G}_{elements} = \{ ∀ graphic \vert \frac{Area ( BBox ( graphics ) ⋂ region )}{min ( Area ( BBox ( graphics ) ) , Area ( region ) )} > {σ}_{2} \} , & \end{matrix}$$
wherein Vₑₗₑₘₑₙₜₛ refers to a document segment set of the corresponding adjacent regional segment; Tₑₗₑₘₑₙₜₛ refers to a character segment set of the corresponding adjacent regional segment; Iₑₗₑₘₑₙₜₛ refers to an image segment set of the corresponding adjacent regional segment; Gₑₗₑₘₑₙₜₛ refers to a graphic segment set of the corresponding adjacent regional segment; BBox( ) refers to calculation of a minimum circumscribed rectangle; Area( ) refers to calculation of an area value; textRun refers to a character segment in the electronic document page; image refers to an image segment in the electronic document page; graphic refers to a graphic segment in the electronic document page; region refers to the corresponding adjacent regional segment prepared to be rasterized; and σ₁ and σ₂ refer to predetermined proportional values.

9. The electronic document rasterizing method according to claim 8, further comprising:
a storage step of storing both resources for rasterizing the adjacent regional segments and the rasterized results.

10. An electronic document rasterizing device comprising:
a thumbnail image rasterizing unit configured to calculate, based on both a size of a display area and a size of an electronic document page, an initial resolution for rasterizing a thumbnail image of the electronic document page, and then to carry out rasterization with regard to the thumbnail image of the electronic document page by utilizing the initial resolution;
an electronic document page dividing unit configured to divide, based on a designated resolution and the size of the display area, the electronic document page into plural regional segments;
a region-of-interest determining unit configured to determine, in response of designation of a position of interest, a current region of interest in the plural regional segments; and
a region-of-interest rasterizing unit configured to determine at least one document segment in the electronic document page, belonging to the current region of interest, and then to rasterize the current region of interest by rasterizing, based on the designated resolution, the document segment belonging to the current region of interest.
